(19) United States
(12) Patent Application Publication
(10) Pub. No.: US 2008/0167862 A1
(43) Pub. Date: Jul. 10, 2008

(54) Pitch Dependent Speech Recognition Engine

(75) Inventor: Keyvan Mohajer, Saratoga, CA (US)

Correspondence Address: HAYNES BEFFEL & WOLFELD LLP, P O BOX 366, HALF MOON BAY, CA, 94019, US

(73) Assignee: Melodis Corporation, Sunnyvale, CA (US)

(21) Appl. No.: 11/971,070

(22) Filed: Jan. 8, 2008

Related U.S. Application Data
(60) Provisional application No. 60/884,196, filed on Jan. 9, 2007.

(51) Int. Cl. G10L 11/04

(52) U.S. Cl. 704/207

(57) ABSTRACT

A method for employing pitch in a speech recognition engine. The process begins by building training models of selected speech samples, a process which begins by analyzing each sample as a sequential series of frames, each frame having a selected duration and overlap with adjacent frames. A pitch estimate of each frame is detected and recorded, and the pitch data is normalized, and the speech recognition parameters of the model are determined, after which the model is stored. Models are stored and updated for each of the set of training samples. The system is then employed to recognizing the speech content of a subject, which begins by analyzing the subject as a sequential series of frames, each frame having a selected duration and overlap with adjacent frames. A pitch estimate for each frame is detected and recorded, and the pitch data is normalized. Speech recognition techniques are then employed to recognize the content of the subject, employing the stored models.

### RELATED APPLICATION

This application claims the benefit of us provisional patent application No. 60/884,196 entitled “Harmonic Grouping Pitch Detection and Application to Speech Recognition Systems,” filed on Jan. 9, 2007. That application is incorporated by reference for all purposes.

### BACKGROUND OF THE INVENTION

The present invention relates to speech recognition systems, and in particular, it relates to the employment of factors beyond speech content in such systems.

Pitch detection has been a topic of research for many years. Multiple techniques have been proposed in the literature. The nature of these techniques is usually strongly influenced by the application that motivates the development of such techniques. Speech researchers have developed pitch detection techniques that work well for speech signals, but not necessarily for musical instruments. Similarly, music researchers have developed techniques that work better for music signals and not as well for speech signals. While some consider the problem of pitch detection to be a solved problem, others view it as an extremely challenging task. The former is correct if one seeks only a rough estimate of the pitch, with speed and accuracy not important. If the application requires fast and accurate pitch tracking, however, and if the signal of interest has undetermined properties, then the problem of pitch detection remains unsolved. The most convincing example of such an application is the field of Automatic Speech Recognition. In spite of numerous improvements in front end signal processing in recent years, pitch information remains a feature not fully utilized in most state of the art speech recognizers. The main reasons for this are, first, the fact that inaccurate pitch information actually degrades performance of a speech recognition system to produces results worse than those obtained without using pitch information at all. Therefore, pitch-dependent speech recognition is only feasible if highly accurate pitch information is available. Additionally, speech recognition is most often implemented in applications requiring real time results, using only limited computational power. The speech recognition system itself usually takes most of the computational resources. Therefore, if a pitch detection algorithm is to be used to extract the pitch contour, this algorithm is required to run in a fraction of real time.

Thus, while the potential benefits of pitch-based speech recognition are clear, the art has not succeeded in providing an operable system to meet that need.

### SUMMARY OF THE INVENTION

An aspect of the claimed invention is a method for employing pitch in a speech recognition engine. The process begins by building training models of selected speech samples, a process which begins by analyzing each sample as a sequential series of frames, each frame having a selected duration and overlap with adjacent frames. A pitch estimate of each frame is detected and recorded, and the pitch data is normalized, and the speech recognition parameters of the model are determined, after which the model is stored. Models are stored and updated for each of the set of training samples. The system is then employed to recognizing the speech content of a subject, which begins by analyzing the subject as a sequential series of frames, each frame having a selected duration and overlap with adjacent frames. A pitch estimate for each frame is detected and recorded, and the pitch data is normalized. Speech recognition techniques are then employed to recognize the content of the subject, employing the stored models.

Pitch data normalization in the method set out immediately above can includes the steps of calculating filterbank energies of each frame; determining a fundamental pitch of each frame; determining a harmonic density of each filterbank; dividing the filterbank energy by the harmonic density for each filterbank; and calculating mel-frequency cepstral coefficients for each frame.

Another aspect of the claimed invention is a method for employing pitch in a speech recognition engine, which begins by building training models of selected speech samples. The training model process begins by analyzing each sample as a speech samples. The training model process begins by analyzing each sample as a sequential series of frames, each frame having a selected duration and overlap with adjacent frames. Then, a pitch estimate of each frame is detected, and each frame is classified into one of a plurality of pitch classifications, based on the pitch estimate. The speech recognition parameters of the sample and determined and a separate sample is stored and updated for each sample, for each preselected pitch range. The speech content of a subject is recognized by the system, commencing with a step of analyzing the subject as a sequential series of frames, each frame having a selected duration and overlap with adjacent frames. The system detects and records a pitch estimate for each frame, and it assigns a pitch classification to each voiced frame, based on the pitch estimate. Applying speech recognition techniques, the system recognizes the content of the subject, employing the set of models corresponding to the pitch classification.

### BRIEF DESCRIPTION OF THE DRAWINGS

FIG. 1 illustrates a general method for speech recognition engines, as known in the art.

FIG. 2 illustrates a process for calculating Mel-scale Frequency Cepstral Coefficient features employed in the art.

FIG. 3 depicts an embodiment of a process for incorporating aspects of the claimed invention into a speech recognition engine.

FIG. 4 illustrates an embodiment of a process for incorporating further aspects of the claimed invention into a speech recognition engine.

FIGS. 5a and 5b show a method for normalizing speech data as incorporated into embodiments of the claimed invention.

FIGS. 6a and 6b illustrate experimental results achieved with embodiments of the claimed invention.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

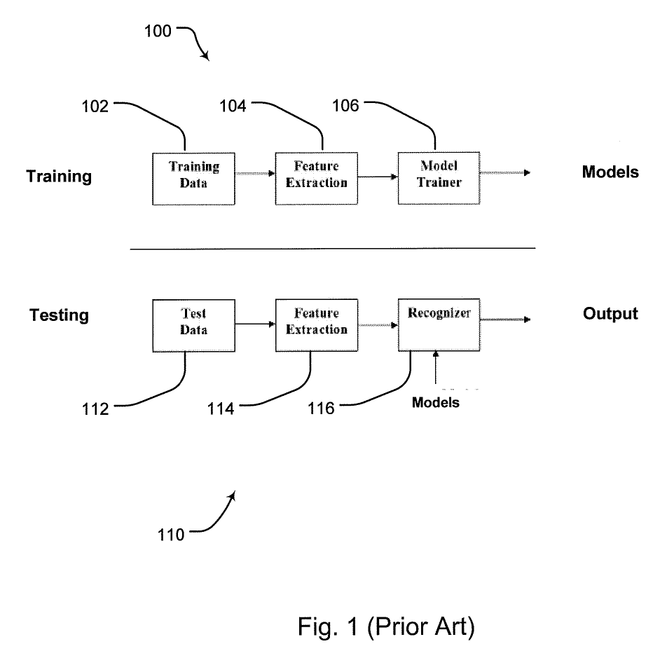

FIG. 1 sets out a basic method for speech recognition, as known in the art. There, the overall process is broken into a training process 100 and a testing process 102. The training process operates on a pre-collected data 102 and produces models, which are then employed in the testing phase 110, which operates on “live” test data 112 to product actual recognition output.

The training stage 100 creates statistical models based on transcribed training data 102. The models may represent phonemes (subwords), words, or even phrases. Phonemes may be context dependent (bi-phones or tri-phones). Once the models are selected, their statistical properties are defined. For example, their PDF (Probability Density Function) can be modeled by a mixture of Gaussian PDFs. The number of mixtures, the dimension of the features, and the restriction on the transition among states (e.g. left-to-right) are all design parameters. An essential part of the training process is the “feature extraction” 104. This building block receives as input the wave data, divides it into overlapping frames, and for each frame generates a set of features, employing techniques such as Mel Frequency Cepstral Coefficients (MFCC), as known in the art. That step is followed by the model trainer 106, which employs conventional modeling techniques to produce a set of trained models.

The testing, or recognition, stage 110 receives a set of speech data 112 to be recognized. For each input, the system performs feature extraction 114 as in the training process. Extracted features are then sent to the decoder (recognizer) 116, which uses the trained models to find the most probable sequence of models that correspond to the observed features. The output of the testing (recognition) stage is a recognized hypothesis for each utterance to be recognized.

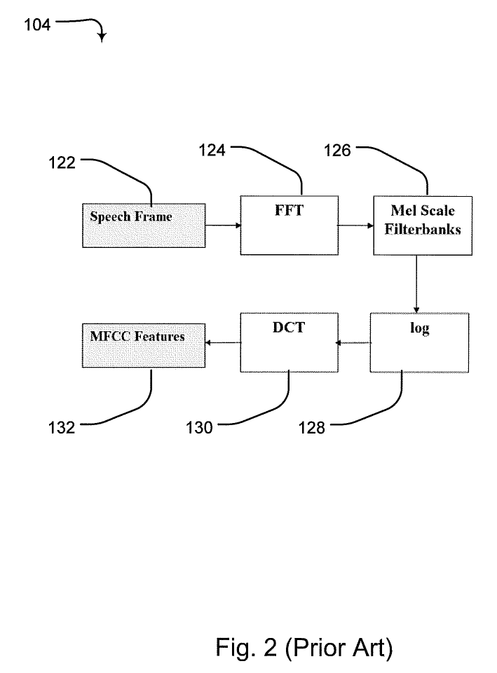

A widely-employed embodiment of a feature recognition method 104 is s the MFCC (Mel-Frequency Cepstral Coefficient) system illustrated in FIG. 2. There, the system divides the audio input into frames of selected length and overlap in step 122, and for every speech frame, an appropriate algorithm is applied at step 124 to calculate the Fast Fourier Transform (FFT) for the frame. The Mel scale is then used to divide the frequency into different bands and the energy of each band is calculated, step 126. Mel-Scale is a logarithmic scale and has proven to resemble human perception of audio signals. That process is fully described in Steve Young et al., The HTK Book, ed. 3.3.

The log of each Mel band energy is then taken and the Discrete Cosine Transform (DCT) of the mel-log-energy vector is calculated, at step 130. The resulting feature vector is the MFCC feature vector, at step 132. Mel-scale energy vectors are usually highly correlated. If the model prototypes are multi-dimensional Gaussian PDFs, a correlated covariance matrix and its inverse needs to be calculated for every Gaussian mixture. This introduces a great deal of complexity to the calculation requirements. The DCT stage is known to de-correlate the features and therefore their covariance matrix can be approximated by a diagonal matrix. In addition, the combination of log and DCT remove the effect of a constant gain from the features. This means x(t) and a*x(t) produce the same features. This is highly desirable since it removes the need to normalize each frame before feature extraction.

A sample calculation follows:

Let x(t) be the time signal and let m1, m2, . . . be the filterbank energies, so that x(t)→[m1, m2, m3 . . .]

Since FFT is linear,

a×x(t)→a2×[m1, m2, m3, . . .] (1)

Taking the log results produces:

2 log (a)+log ([m1, m2, m3, . . .]) (2)

The 2 log (a) term acts as a DC bias with respect to the filter bank dimension. Therefore, after taking the DCT, 2 log (a) only appears in the zero-th Cepstral coefficient C0 (the DC component). This coefficient is usually ignored in the features.

Speech consists of phonemes (sub-words). Various phonemes and their categories in American English are provided by the TIMIT database commissioned by DARPA, with participation of companies such as Texas Instruments and research centers such as Massachusetts Institute of Technology (hence the name). The database is described in the DARPA publication, The DARPA TIMIT Acoustic-Phonetic Continuous Speech Corpus (TIMIT).

Phonemes can also be classified into voiced phonemes and unvoiced phonemes. Voiced phonemes are generally vowel sounds, such as /a/ or /u/, while unvoiced are generally consonants, such as /t/ or /p/. Unvoiced phonemes have no associated pitch information, so no calculation is possible. The system must recognize unvoiced samples, however, and make provision for dealing with them. Voiced phonemes such as (/aa/, /m/, /w/, etc.) are quasi-periodic signals and contain pitch information. As known in the art, such quasi-periodic signals can be modeled with a convolution in time domain or a multiplication in the frequency domain:

s(t)=(e·h)(t)→S(F)=E(F)H(F) (3)

Here, s(t) is the time domain speech signal, e(t) is the pitch-dependent excitation signal that can be modeled as a series of pulses, and h(t) is the pitch-independent filter that contains the phoneme information. In frequency domain, E(f) is a series of deltas equally spaced with fundamental frequency. S(f) therefore consists of samples of H(f) at harmonics of the fundamental (pitch) frequency. The observation of S(f) is therefore dependent on the pitch estimate. The analytical goal is to explore how knowledge of pitch can help to better recognize the underlying H(f) which contains the phoneme information.

An important question is how additional pitch information, and the manner of using it in a speech recognition system affects the system's accuracy. As known in the art, the accuracy of a speech recognition system depends on a variety of factors. Improving the quality of features improves the system and brings closer the achievement of a context-independent, speaker-independent and highly accurate speech recognition system. However, in small systems with limited vocabulary, the use of language models and context dependency may mask the direct improvement made by the improvements in features.

Table 1 shows various measures of accuracy using the TIMIT database. Frame level recognition does not use any context dependency or language model. It represents the number of frames correctly classified as a phoneme using a single mixture 12-dimensional Gaussian PDF modeling 12-dimensional MFCC features. The accuracy represented by this number significantly depends on the quality of the features. We will therefore use the frame-level recognition rate in this chapter. We use TIMIT database with phoneme level labels. Only voiced phonemes are considered and each of the 34 voiced phonemes is modeled with a single mixture Gaussian PDF.

TABLE 1
Speech Recognition Benchmarking

| Criteria | % of correct match |
|---|---|
| Frame Level | 44% |
| Phone Level with HMM | 51% |
| Word Level with HMM | 72% |
| Context Dependent Word Level | >90% |

Since the observation S(f) and therefore the features extracted from it are affected by the value of the pitch, one way to use knowledge of pitch is to train and use “pitch-dependent models”. This concept is similar to the highly researched topic of “gender-dependent models” in which different models are trained and used for male and female speakers. Gender-dependent models have been shown to improve the recognition accuracy. However, their use requires knowledge of the gender of the speaker.

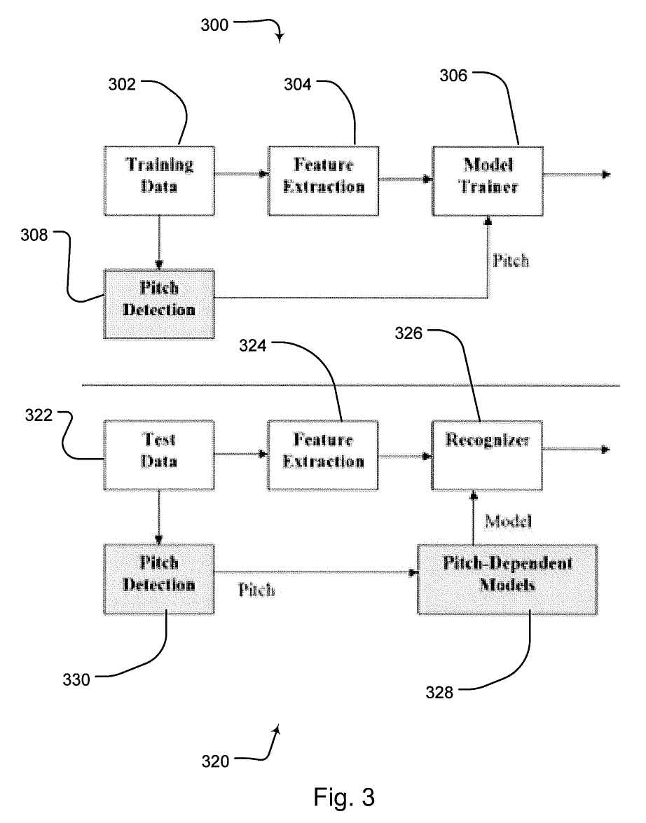

FIG. 3 depicts an embodiment 300 of the claimed invention that modifies prior art systems by employing pitch-dependent models. This embodiment retains some features of the known system of FIG. 1, such as the two-phase division of training phase 300 and test phase 320, as well as specific components, including training data step 302, feature extraction 304 and model trainer steps 306 in the training phase, and the test data step 322, feature extraction 324 and recognizer step 326. Here, however, a parallel process is added, handling pitch information. The training phase includes a pitch detection step 308, which feeds pitch estimates to the model trainer 306. The pitch estimate is then used in the Model trainer to create pitch-dependent models. In one embodiment, the pitch detection step returns a value that relates to the average pitch estimate of the phoneme or other data item under analysis. Other embodiments return values based on some weighted value, which can be weighted by time, duration or other variable. To accomplish this result, any of the many various pitch detection systems known to those in the art can be employed.

In the embodiment under discussion, pitch is employed to classify the data into one of a number of pitch classes or bins. The number of classes or bins selected for a given application will be selected by those in the art as a tradeoff between accuracy (more bins produce greater accuracy) and computational resources (more bins require more computation). Systems employing two and three bins have proved effective and useful, while retaining good operational characteristics. Note that pitch classification includes dealing with unvoiced phonemes.

During the test, or recognition, phase 320, a similar parallel operation occurs, with pitch detection step 330 detecting the pitch employing the same weighting or calculating algorithm as was used for the training data. That pitch information is fed to pitch selection step 328, where the value is used to select the appropriate model from among the sets of pitch-dependent models built during the training phase. Thus, when the model data is fed to recognizer step 326, the model employed is not a generic dataset, as is the case with the prior art, but a model that matches the test data in pitch classification.

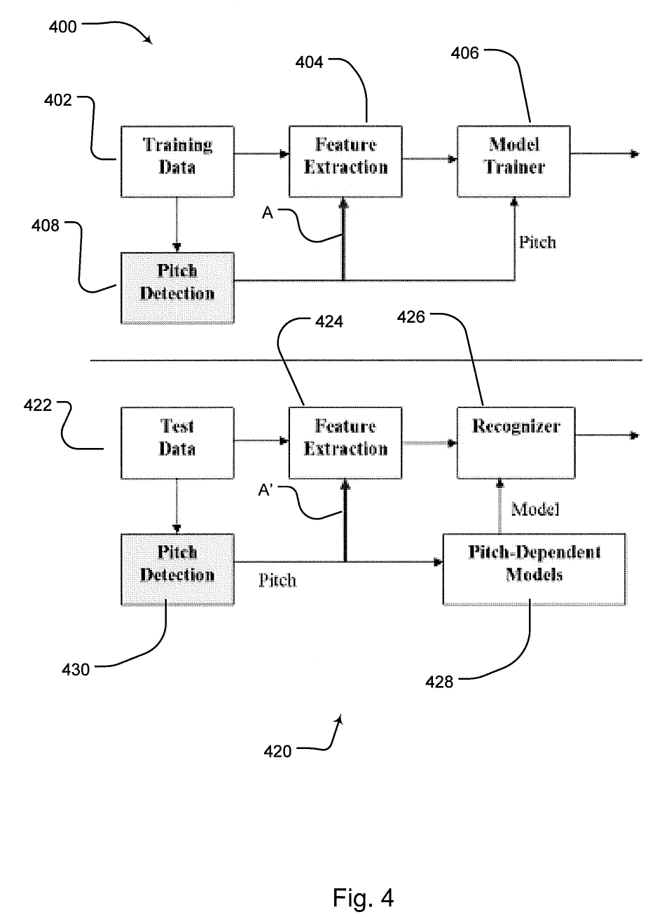

The dramatic improvement in accuracy is easily seen in FIG. 4, which shows the results of using both prior art and pitch-dependent models, based on a frame-level recognition rate. All embodiments under evaluation used MFCC Models with a 25 ms Hamming window frame duration, 50% overlap, 24 filterbanks and 12 Cepstral coefficients. The first bar on the left reflects the base-level recognition rate using a single model, as known in the art. The second bar is the result for a “gender-dependent” model known in the art, and is shown to illustrate improves accuracy compared to the single model system. The third bar is the result for the pitch-dependent model system where two pitch bins are used. For this system one model corresponds to pitch estimates less than 175 Hz and one model corresponds to pitch estimates higher than 175 Hz. The accuracy of the 3-pitch-dependent model system is significantly higher than the previous systems, as shown in the middle bar. For higher numbers of bins, however, as the pitch-bin resolution is increased (higher number of pitch bins and therefore higher number of pitch-dependent models), the accuracy decreases, owing to a lack of training data in each pitch bin. It is expected that a higher volume of training data would solve this problem.

Although the embodiment of FIG. 3 achieves highly improved rates over the prior art, it does requires multiple models, further requiring sufficient training data for each model. The embodiment of FIG. 4 addresses those concerns, using pitch information in an embodiment 400 that employs only a single model, but which also achieves high accuracy rates. That embodiment is diagrammatically very similar to the embodiment of FIG. 3, having the same functional blocks, but it includes arrows A and A′. The former arrow feeds pitch information to the feature extraction step 404 in the training phase, while arrow A′ does the same in the test phase.

Pitch provides considerably increased accuracy, as seen above, but in conventional systems that accuracy is obtained at a cost. First, training conventional, complicated models entails handling a large number of Gaussian Mixtures, which imposes significant computational overhead. Further, such training requires additional training data, which must be gathered and conditioned for use. The embodiment of FIG. 4 more fully employs pitch to retain the accuracy advantages without the computational and additional data costs inherent in the prior art approach. In general, the technique of this embodiment may be described as pitch normalization—conditioning the data to remove the effect of pitch from the speech information encoded in the features.

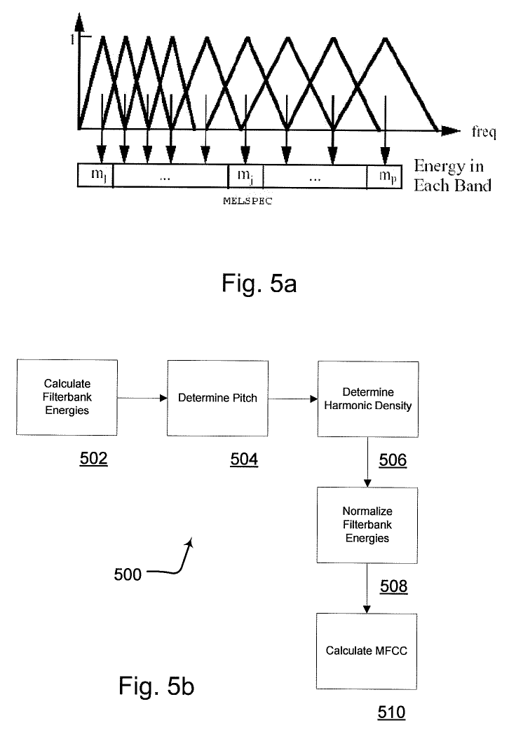

An embodiment of a method for achieving that result is shown in FIGS. 5a and 5b. FIG. 5a returns to Eq. 3, showing application of an FFT to a speech signal as a plot of energy as a function of frequency. As described above, a speech signal is divided into discrete frames, and the signal in each frame is analyzed to provide a pitch estimate. The classification scheme here follows source-filter theory, as shown in Eq. 3, to plot the energy in each bin as the product of a filter function H(f) and an excitation function E(f). As with the earlier embodiment, classification includes a provision for recognizing unvoiced phonemes, which have no pitch information, and such frames are not considered. Therefore, different pitch estimates may result in different number of samples of H(f) in various bands [m1, m2, m3, . . .]. The plot here on taken on a Mel scale, and the non-linear nature of that scale means that the difference in the number of samples in each bin is also not linear. Thus, one can divide the frequency range into banks, and the signal energy in each such bank will indicate the number of harmonics present in that bank.

The results of such a calculation are shown in Table 2. Each row shows a different filter bank in the Mel scale. The first column shows the frequency range for that filter bank, the second column shows the number of harmonics in that filter bank for a 150 Hz signal, and the third column shows the number of harmonics for a 200 hz signal.

TABLE 2
Harmonics dependent on f₀

| Filter Bank | | Pitch: 150 Hz | Pitch: 200 Hz |
|---|---|---|---|
| 77-163 | Hz | 1 Harmonic | 0 Harmonics |
| 163-260 | Hz | 0 Harmonics | 1 Harmonic |
| 2685-3055 | | 3 Harmonics | 2 Harmonics |
| 4446-5016 | | 4 Harmonics | 3 Harmonics |

It should be noted that each bin is scaled by a non-constant factor due to this pitch difference imposed by conversion to the Mel scale.

FIG. 5b illustrates a process 500 for normalizing the pitch data. First, in step 502, the filterbank energies are calculated, as shown above, and the energies for each bin are calculated, producing [m1, m2, m3, . . .]. Then, the fundamental pitch f₀ is determined, step 504, as also described above, with provision being made for unvoiced (pitchless) phonemes in frames. That information allows the calculation of harmonic density, D1=number of harmonics of f₀ in ith bin, step 506. Step 508 normalizes the filterbank energies by the number of harmonics present, so that for each filterbank Mi =mᵢ/Dᵢ. Note that if no harmonics are present in a bin, the system can interpolate with adjacent bins. Typically that measure is only required in the first filter bank. At that point, sufficient data is available to allow computation of the MFCC as known in the art, using the normalized energy vector by taking log and DCT.

Another embodiment employs analysis techniques to achieve improvements over simple normalization. Drawing upon techniques similar to those presented in the study by Xu Shao and Ben Milner, entitled “Predicting Fundamental Frequency from mel-Frequency Cepstral coefficients to Enable Speech Reconstruction,” published in the Journal of the Acoustical Society of America in August 2005 (p. 1134-1143), here one can adjust the density and location of the harmonics found in each filterbank, making both parameters correspond to those of a preselected pitch value.

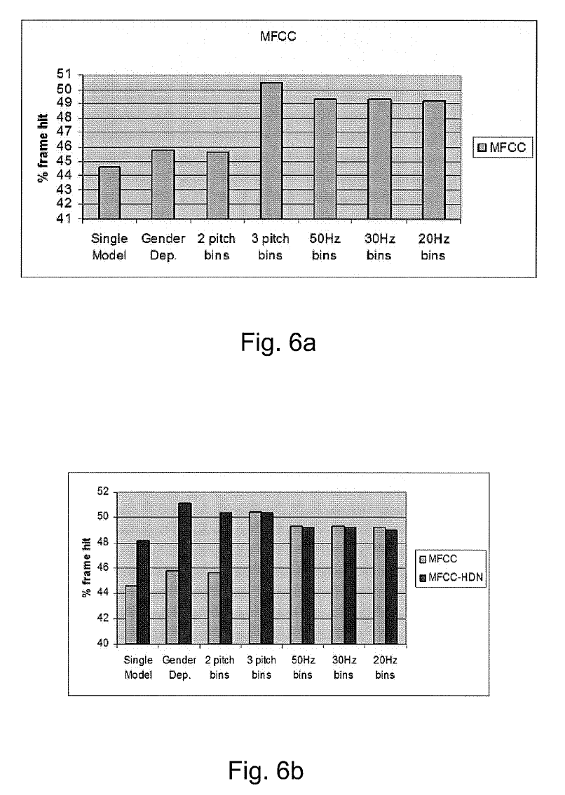

The process of FIG. 5b can be termed “Harmonic Density Normalization,” so that the results can be termed MFCC-HDN. Experimental results employing MFCC-HDN (following the protocol discussed in connection with FIG. 3) are shown in FIG. 6, which shows the results of MFCC-HDN together with those of MFCC. Note the significant improvement by using 2-pitch-dependent models with MFCC-HDN features. As expected, the improvement of using MFCC-HDN diminishes as the models become more pitch dependent since the effect of HDN becomes less significant in that case.

Some embodiment of the claimed invention can be combined with the system of FIG. 3, particularly in situations where models have been previously trained. Rather than repeating the time-consuming training process, MFCC-HDN can be used such cases with an additional stage of multiplying the normalized energies by a scale that corresponds to the dominant pitch of the training data set. This dominant pitch can be searched for using an exhaustive search that results in the maximum accuracy in a test set. Those of skill in the art can implement such a system.

It is contemplated that modifications and combinations will readily occur to those skilled in the art, which modifications and combinations will be within the spirit of the invention and the scope of the following claims.

We claim as follows:

1. A method for employing pitch in a speech recognition engine, comprising the steps of
building training models of selected speech samples, including the steps of
analyzing each sample as a sequential series of frames, each frame having a selected duration and overlap with adjacent frames;
detecting and recording a pitch estimate of each frame;
classifying the frames into one of a plurality of pitch classifications, based on the pitch estimate;
determining speech recognition parameters of the sample;
storing and updating separate models for each preselected pitch range, for each selected sample;
recognizing the speech content of a subject, including the steps of
analyzing the subject as a sequential series of frames, each frame having a selected duration and overlap with adjacent frames;
detecting and recording a pitch estimate for each frame;
assigning a pitch classification to each voiced frame, based on the pitch estimate;
applying speech recognition techniques to recognize the content of the subject, employing the set of models corresponding to each pitch classification.

2. The method of claim 1, wherein the classifying step produces two pitch classifications.

3. The method of claim 1, wherein the classifying step produces three pitch classifications.

4. The method of claim 1, wherein the classification step includes the step of recognizing and appropriately classifying an unvoiced sample.

5. The method of claim 4, wherein the appropriate classification for an unvoiced sample results in that sample being not further considered by the system.

6. A method for employing pitch in a speech recognition engine, comprising the steps of
building training models of selected speech samples, including the steps of
analyzing each sample as a sequential series of frames, each frame having a selected duration and overlap with adjacent frames;
detecting and recording a pitch estimate of each frame;
normalizing sample for pitch data;
determining speech recognition parameters of the sample;
storing and updating a model for each sample;
recognizing the speech content of a subject, including the steps of
analyzing a subject as a sequential series of frames, each frame having a selected duration and overlap with adjacent frames;
detecting and recording the pitch estimate of the subject;
normalizing the sample for pitch data;
applying speech recognition techniques to recognize the content of the subject, employing the stored models.

7. The method of claim 6, wherein pitch data normalization is based on a calculation of mel-frequency cepstral coefficients.

8. The method of claim 6, wherein pitch data normalization is based on a calculation of harmonically normalized mel-frequency cepstral coefficients.

9. The method of claim 6, wherein the normalization step includes the steps of
calculating filterbank energies of each frame;
determining a fundamental pitch of each frame;
determining a harmonic density of each filterbank;
dividing the filterbank energy by the harmonic density for each filterbank; and
calculating mel-frequency cepstral coefficients for each frame.

10. The method of claim 6, wherein the normalization step includes the steps of
calculating filterbank energies of each frame;
determining a fundamental pitch of each frame;
determining a harmonic density of each filterbank;
adjusting the density and location of the harmonics in each filterbank to those of a preselected pitch value; and
calculating mel-frequency cepstral coefficients for each frame.

11. A method for employing pitch in a speech recognition engine, comprising the steps of
building training models of selected speech samples, including the steps of
analyzing each sample as a sequential series of frames, each frame having a selected duration and overlap with adjacent frames;
detecting and recording a pitch estimate of each frame;
normalizing the sample for pitch data, including the steps of
calculating filterbank energies of each frame;
determining a fundamental pitch of each frame;
determining a harmonic density of each filterbank;
dividing the filterbank energy by the harmonic density for each filterbank; and
calculating mel-frequency cepstral coefficients for each frame;
determining speech recognition parameters of the sample;
storing and updating a model for each sample;
recognizing the speech content of a subject, including the steps of
analyzing a subject as a sequential series of frames, each frame having a selected duration and overlap with adjacent frames;
detecting and recording the pitch estimate of the subject;
normalizing the sample for pitch data, including the steps of
calculating filterbank energies of each frame;
determining a fundamental pitch of each frame;
determining a harmonic density of each filterbank;
dividing the filterbank energy by the harmonic density for each filterbank; and
calculating mel-frequency cepstral coefficients for each frame;
applying speech recognition techniques to recognize the content of the subject, employing the stored models.

12. A method for employing pitch in a speech recognition engine, comprising the steps of
building training models of selected speech samples, including the steps of
analyzing each sample as a sequential series of frames, each frame having a selected duration and overlap with adjacent frames;
detecting and recording a pitch estimate of each frame;
normalizing the sample for pitch data, including the steps of
calculating filterbank energies of each frame;
determining a fundamental pitch of each frame;
determining a harmonic density of each filterbank;
adjusting the density and location of the harmonics in each filterbank to those of a preselected pitch value; and
calculating mel-frequency cepstral coefficients for each frame;
determining speech recognition parameters of the sample;
storing and updating a model for each sample;
recognizing the speech content of a subject, including the steps of
analyzing a subject as a sequential series of frames, each frame having a selected duration and overlap with adjacent frames;
detecting and recording the pitch estimate of the subject;
normalizing the sample for pitch data, including the steps of calculating filterbank energies of each frame;
determining a fundamental pitch of each frame;
determining a harmonic density of each filterbank;
adjusting the density and location of the harmonics in each filterbank to those of a preselected pitch value; and
calculating mel-frequency cepstral coefficients for each frame;
applying speech recognition techniques to recognize the content of the subject, employing the stored models.
